(19) United States
(12) Patent Application Publication
(10) Pub. No.: US 2016/0205203 A1
(43) Pub. Date: Jul. 14, 2016

(54) Method for active notification for interaction between electronic devices, and electronic device thereof

(71) Applicant: Samsung Electronics Co., Ltd, Suwon-si (KR)

(72) Inventors: Sungjin Choi, Yongin-si (KR); Sunghyun Park, Seoul (KR); Hyunsik Yoon, Seoul (KR); Youngsub Lee, Suwon-si (KR); Soonyong Cho, Suwon-si (KR)

(21) Appl. No.: 14/757,639

(22) Filed: Dec. 24, 2015

(30) Foreign Application Priority Data
Dec. 23, 2014 (KR) 10-2014-0186723

(51) Int. Cl. H04L 29/08; H04L 12/24

(52) U.S. Cl. CPC H04L 67/16; H04L 41/0806; H04L 67/24

(57) ABSTRACT

An electronic device for executing an active notification for an interaction between electronic devices includes: a memory for matching a predetermined event and a predetermined service, and storing the same; a communication unit for executing the transmission and reception of an active notification, and information associated with the predetermined service, with external electronic devices over a network, based on whether the predetermined event occurs; and a controller for executing a process in order to recognize, using the communication unit, the entrance of an external electronic device into the network, to receive the active notification from the external electronic device, to determine whether to execute the predetermined service based on the received active notification, to exchange the information associated with the predetermined service with the external electronic device when it is determined that the predetermined service is to be executed, and to execute the predetermined service based on the information.

### CROSS-REFERENCE TO RELATED APPLICATION(S) AND CLAIM OF PRIORITY

The present application is related to and claims the benefit of priority under 35 U.S.C. §119(a) of Korean Patent Application No. 10-2014-0186723, filed on Dec. 23, 2014, which is hereby incorporated by reference for all purposes as if fully set forth herein.

### TECHNICAL FIELD

The present disclosure relates generally to an active notification method and an electronic device thereof, which enables a new electronic device to readily operate together with existing electronic devices, and enables an interaction between electronic devices in association with a new service.

### BACKGROUND

Recently, users have come to possess various types of electronic devices (for example, a smart phone, a tablet Personal Computer (PC), a blueray disc, a printer, a wireless speaker, and the like), and the electronic devices may exchange and playback contents by connecting with each other over a network.

To this end, a user configures the settings to enable new electronic devices to be connected with existing electronic devices, so that the connected devices may execute an interaction.

### SUMMARY

However, a user may have difficulty configuring the settings due to the unfamiliar and complex configuration process. Also, when a new electronic device is connected with existing electronic devices, a user may be unaware of a new function that may be executed with the external electronic devices, and may not utilize the connected electronic device well.

To address the above-discussed deficiencies, it is a primary object to provide an active notification method for the interaction between electronic devices and an electronic device thereof, which enables a new electronic device to readily operate together with existing electronic devices through an interaction between electronic devices, and enables the interaction between electronic devices in association with a new service.

According to various embodiments of the present disclosure, there is provided an electronic device, which includes: a memory for matching a predetermined event and a predetermined service, and storing the same; a communication unit for executing the transmission and reception of an active notification and information associated with the predetermined service, with external electronic devices over a network, based on whether the predetermined event occurs; and a controller for executing a process in order to recognize, using the communication unit, the entrance of an external electronic device into the network, to receive the active notification from the external electronic device, to determine whether to execute the predetermined service based on the received active notification, to exchange the information associated with the predetermined service with the external electronic device when it is determined that the predetermined service is to be executed, and to execute the predetermined service based on the information.

According to various embodiments of the present disclosure, there is provided a method of executing active notification for the interaction between electronic devices, the method including: recognizing the entrance of an external electronic device into a network; receiving an active notification from the external electronic device; determining whether to execute a predetermined service based on the received activation notification; exchanging, with the external electronic device, information required to execute the predetermined service when it is determined that the predetermined service is to be executed; and executing the predetermined service based on the received information.

According to various embodiments of the present disclosure, there is provided an electronic device, including: a memory for matching a predetermined event and a predetermined service, and storing the same; a communication unit for executing the transmission and reception of an active notification and information associated with the predetermined service with external electronic devices over a network based on whether the predetermined event occurs; and a controller for executing a process in order to execute entrance into the network, to inform the external electronic device of whether the entrance is executed, to transmit an active notification to the external electronic device, to receive, from the external electronic device, an execution command for the predetermined service based on the active notification, and to exchange information required for the external electronic device to execute the predetermined service.

According to various embodiments of the present disclosure, there is provided a method of executing active notification for the interaction between electronic devices, the method including: entering a network, and informing an external electronic device of whether the entrance is executed; transmitting an active notification to the external electronic device; receiving an execution command for a predetermined service from the external electronic device; and exchanging, with the external electronic device, information required to execute the predetermined service.

According to various embodiments of the present disclosure, there is provided an active notification method for the interaction between electronic devices and an electronic device thereof, by which the configuration of settings that enables a plurality of electronic device to operate together is readily executed.

Also, the method and electronic device may report mutually usable services between electronic devices, may guide a user to use the services, and may help the user to maximally utilize the electronic devices, so that a user's experience may be maximized.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a block diagram of an electronic device according to various embodiments of the present disclosure;

FIG. 2 illustrates a configuration of a network according to various embodiments of the present disclosure;

FIG. 3 illustrates a configuration of a network according to various embodiments of the present disclosure;

FIG. 4 illustrates a process of configuring settings between electronic devices according to various embodiments of the present disclosure;

FIG. 5 illustrates a process of executing a service that is mutually usable between electronic devices according to various embodiments of the present disclosure;

FIG. 6 illustrates a process of executing a service that is mutually usable between electronic devices according to various embodiments of the present disclosure; and

FIGS. 7A to 7C illustrate an active notification according to various embodiments of the present disclosure.

### DETAILED DESCRIPTION

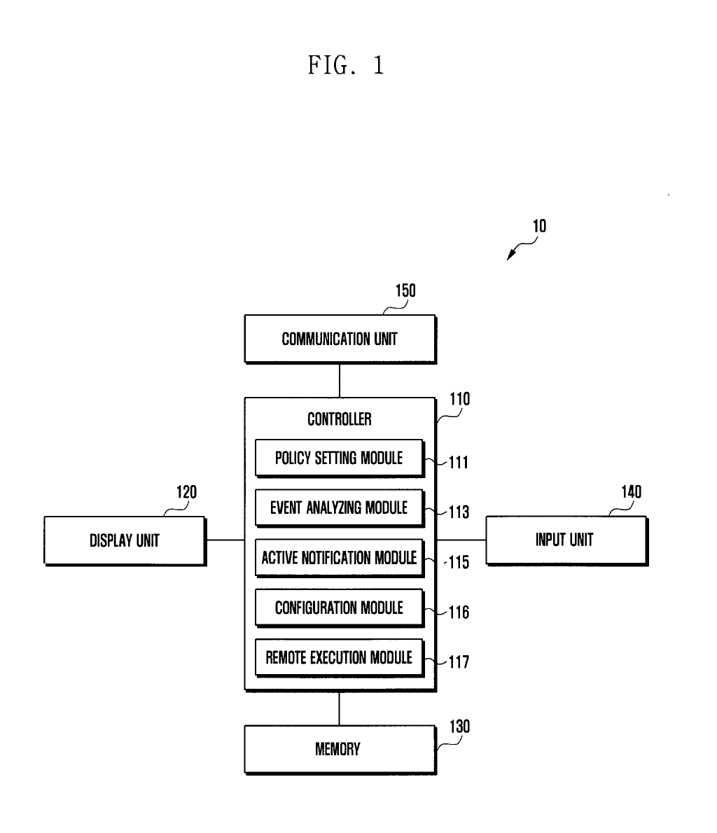

FIGS. 1 through 7C, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless communication system. Hereinafter, embodiments of the present disclosure will be described in detail with reference to the accompanying drawings. It will be easily appreciated to those skilled in the art that various modifications, additions and substitutions are possible from the embodiments of the present disclosure, and the scope of the disclosure should not be limited to the following embodiments. The embodiments of the present disclosure are provided such that those skilled in the art completely understand the disclosure. In the drawings, the same or similar elements are denoted by the same reference numerals even though they are depicted in different drawings.

The expressions such as “include” and “may include” which may be used in the present disclosure denote the presence of the disclosed functions, operations, and constituent elements and do not limit one or more additional functions, operations, and constituent elements. In the present disclosure, the terms such as “include” and/or “have” may be construed to denote a certain characteristic, number, step, operation, constituent element, component or a combination thereof, but may not be construed to exclude the existence of or a possibility of the addition of one or more other characteristics, numbers, steps, operations, constituent elements, components or combinations thereof.

In the present disclosure, the expression “and/or” includes any and all combinations of the associated listed words. For example, the expression “A and/or B” may include A, may include B, or may include both A and B.

The terms used in the present disclosure are only used to describe specific various embodiments, and are not intended to limit the present disclosure. Singular forms are intended to include plural forms unless the context clearly indicates otherwise.

Unless otherwise defined, all terms including technical and/or scientific terms used herein have the same meaning as commonly understood by one of ordinary skill in the art to which the disclosure pertains. In addition, unless otherwise defined, all terms defined in generally used dictionaries may not be overly interpreted.

Hereinafter, electronic devices according the embodiments of the present disclosure are described in detail with reference to the accompanying drawings. In the description, the term a ‘user’ may be referred to as a person or a device that uses an electronic device, for example, an artificially intelligent electronic device.

FIG. 1 is a block diagram of an electronic device according to various embodiments of the present disclosure.

Referring to FIG. 1, an electronic device 10 may include a controller 110, a display unit 120, a memory 130, an input unit 140, and a communication unit 150.

For example, the electronic device 10 may include at least one of a smart phone, a tablet Personal Computer (PC), a mobile phone, a video phone, an e-book reader, a desktop PC, a laptop PC, a netbook computer, a Personal Digital Assistant (PDA), a Portable Multimedia Player (PMP), an MP3 player, a mobile medical device, a camera, a wearable device (for example, a Head-Mounted-Device (HMD) such as electronic glasses, electronic clothes, an electronic bracelet, an electronic necklace, an electronic appcessory, an electronic tattoo, and a smart watch).

According to some embodiments, the electronic device 10 may be a smart home appliance. The smart home appliance as an example of the electronic device 10 may include at least one of a television, a Digital Video Disk (DVD) player, an audio, a refrigerator, an air conditioner, a vacuum cleaner, an oven, a microwave oven, a washing machine, an air cleaner, a set-top box, a TV box (e.g., Samsung HomeSync™, Apple TV™, or Google TV™), a game console, an electronic dictionary, an electronic key, a camcorder, and an electronic picture frame.

According to some embodiments, the electronic device 10 may include at least one of various medical appliances (e.g., magnetic resonance angiography (MRA), magnetic resonance imaging (MRI), computed tomography (CT), and ultrasonic machines), navigation equipment, a global positioning system (GPS) receiver, an event data recorder (EDR), a flight data recorder (FDR), automotive infotainment device, electronic equipment for ships (e.g., ship navigation equipment and a gyrocompass), avionics, security equipment, a vehicle head unit, an industrial or home robot, an automatic teller machine (ATM) of a banking system, and a point of sales (POS) of a shop.

According to some embodiments, the electronic device 10 may include at least one of a part of furniture or a building/structure, an electronic board, an electronic signature receiving device, a projector, and various kinds of measuring instruments (e.g., a water meter, an electric meter, a gas meter, and a radio wave meter). The electronic device 10 according to an embodiment of the present disclosure may correspond to one of the aforementioned various devices or a combination thereof.

The controller 110 may control overall operations of the electronic device 10 and the signal flow between internal components of the electronic device 10, and may perform a data processing function for processing data. For example, the controller 110 may be formed of a Central Processing Unit (CPU), an Application Processor (AP), and the like. Also, the controller 110 may be embodied as a single-core processor or a multi-core processor.

The controller 110 may include a policy setting module 111, an event analyzing module 113, an active notification module 115, a configuration module 116, and a remote execution module 117.

The policy setting module 111 sets a predetermined event, and sets a policy and a rule to execute a predetermined service when the predetermined event occurs. When an electronic device is a camera, the predetermined event may be set to be an event in which the electronic device enters a user network, and a predetermined service that is matched to the predetermined event may be an operation of displaying a slide show. This may be matched to the predetermined service by a user, and may be stored in the memory 130. Also, a predetermined event and a predetermined service may be set in a manufacturing process based on the characteristics of the electronic device 10, and may be stored in the memory 130.

For example, when a user captures a photo with a camera outside and enters a house where a user network is configured, the electronic device 10 may enter the user network. The entrance into the user network is set as the predetermined event in the camera of the electronic device 10, and thus, the electronic device may execute the slide show, which is the predetermined service.

The event analyzing module 113 may analyze an event that occurs in various embodiments, and may determine whether the event is a predetermined event. The event analyzing module 113 may sense various events in various environments. The event may be the reception of a message, the reception of a phone call, the notification of an application, driving a camera, and the like.

From the perspective of the above example, the event analyzing module 113 may recognize, through the communication unit 150, that the electronic device 10 enters a network, and may determine whether the event is a predetermined event. When the event analyzing module 113 determines that the event is a predetermined event, the event analyzing module 113 may instruct the active notification module 115 to provide an active notification.

The active notification module 115 may be aware that a predetermined event occurs from the event analyzing module 113, and receives a command for displaying a notification. Although it is described that the active notification module 115 displays a notification, the present disclosure may not be limited thereto. The active notification module 115 may inform a user of a notification through various methods, such as a visual method, an acoustic method, or the like. The user may select a notification that is displayed by the active notification module 115, and may determine whether to execute a predetermined service.

The configuration module 116 may execute the operation of pairing two electronic devices, and may configure the settings required between the two electronic devices.

When the user selects a notification that is displayed by the active notification module 115, and determines to execute a predetermined service, for example, configuring settings, the configuration module 116 executes pairing with an electronic device with which the configuration of the settings is executed, and exchanges information required for configuring the settings.

When downloading a driver, apps, and the like are needed based on the exchanged information, the configuration module 116 downloads the driver, apps, and the like from the user network and installs the same. The configuration module 116 may configure the settings through the downloaded driver, apps, or the like.

By receiving the configuration information from an electronic device to be paired, the configuration module 116 may eliminate the burden for the user to search from an app store or the like, for a driver, apps, or the like in association with the electronic device.

The remote execution module 117 may exchange data required for executing a predetermined service between electronic devices that are paired by the configuration module 116, and may actually enable the execution of a function.

Also, when only external electronic devices are paired, the remote execution module 117 may determine whether it is possible that only the external electronic devices execute a predetermined service. A notification is received from the active notification module 115 that is included in an external electronic device. Based on whether the remote execution module 117 selects the notification, whether it is possible that only the two external electronic devices execute the predetermined service may be determined.

The display unit 120 may be an integrated type in which a display panel and a touch panel are coupled in a layer structure. The display panel may be embodied in various types, such as a liquid crystal display (LCD), an organic light emitting diode (OLED) display, an active-matrix organic light-emitting diode (AM-OLED), a plasma display panel (PDP), and the like.

The display panel may be embodied to be, for example, flexible, transparent, or wearable. The touch panel may recognize a touch input based on at least one scheme among, for example, a capacitive scheme, a resistive scheme, an infrared scheme, and an ultrasonic scheme.

The display unit 120 may display an active notification by the controller, and particularly, by the active notification module 115. The display 120 may display the active notification in the bottom or the center of the display unit 120, so that a user determines the same.

Also, when the controller receives, through the communication unit 150, an active notification display command from another electronic device, the display unit 120 receives the command of the controller 110 for displaying the active notification, and displays the active notification.

The memory 130 may include at least one of an internal memory and an external memory.

The internal memory may include, for example, at least one of a volatile memory (for example, a dynamic random access memory (DRAM), a static random access memory (SRAM), a synchronous dynamic random access memory (SDRAM) and the like), a non-volatile memory (for example, an one time programmable read only memory (OTPROM), a programmable read only memory (PROM), an erasable and programmable read only memory (EPROM), an electrically erasable and programmable read only memory (EEPROM), a mask read only memory, a flash read only memory, and the like), a hard disk drive (HDD), and a solid state drive (SSD).

The external memory may include, for example, at least one of a compact flash (CF), a secure digital (SD), a micro secure digital (Micro-SD), a mini secure digital (Mini-SD), an extreme digital (xD), and a memory stick.

The memory 130 may store a predetermined event. The memory 130 may store a predetermined service that is matched to the predetermined event, in addition to the predetermined event.

A predetermined event and a predetermined service matched thereto may be stored in the memory 130 in a different manner based on the characteristic of the electronic device 10. Also, a predetermined event and a predetermined service are matched based on settings by a user, and may be stored in the memory 130.

The communication unit 150 may connect communication between the electronic device 10 and an external electronic device. For example, the communication unit 150 may be connected to a network via wireless or wired communication so as to communicate with an external device. The wireless communication may include, for example, wireless fidelity (Wifi), Bluetooth (BT), Bluetooth low energy (BLE), and near field communication (NFC). The wireless communication may also include at least one type of cellular communications (for example, LTE, LTE-A, CDMA, WCDMA, UMTS, WiBro, GSM, and the like). According to an embodiment of the present disclosure, a user network may be established through a wired/wireless sharer (Access Point (AP)). Each of the electronic devices connected to a user network may determine the state of each electronic device based on information that each communication unit 150 receives from the wired/wireless sharer. When the electronic device 10 that is connected to the user network is in a sleep state, the electronic device 10 may wake up from the sleep state by another electronic device that is connected to the electronic device 10. The other electronic device may transmit a wakeup command to the electronic device 10 through the communication unit of the other electronic device.

The wired communication may include, for example, at least one of a universal serial bus (USB), a high definition multimedia interface (HDMI), recommended standard 232 (RS-232), and a plain old telephone Service (POTS).

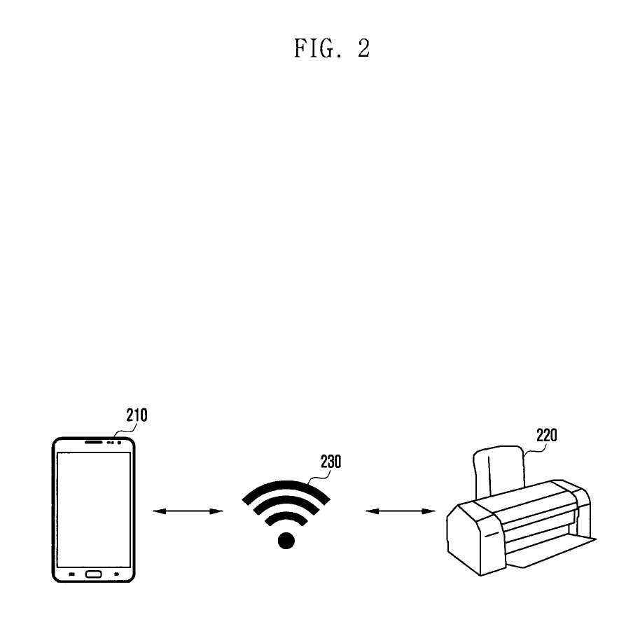

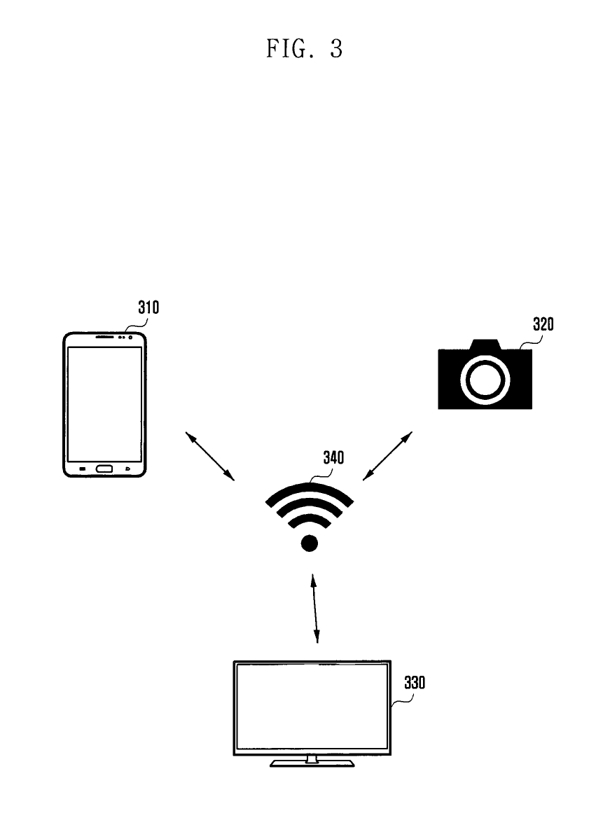

FIG. 2 illustrates a configuration of a network according to various embodiments of the present disclosure. FIG. 3 illustrates a configuration of a network according to various embodiments of the present disclosure.

Referring to FIG. 2, the configuration of a network according to various embodiments of the present disclosure may include a first electronic device 210, at least one wired/wireless sharer 230, and a second electronic device 220. The description is provided by assuming that the first electronic device 210 in the configuration is a smart phone and the second electronic device 220 is a printer. The wired/wireless sharer 230 may generate a user network.

According to an embodiment of the present disclosure, an example will be described, in which the configuration of settings is executed between two electronic devices.

The first electronic device 210 may enter a user network. The entrance into the network may be executed when a user makes a selection. The second electronic device 220 may enter the user network where the first electronic device 210 has entered. The wired/wireless sharer 230 may transmit, to the first electronic device 210, information indicating that the second electronic device 220 enters the user network. The first electronic device 210 may receive information through a communication unit. A predetermined event set in the second electronic device 220 may be the entrance into the user network, and a predetermined service that is stored by being matched to the predetermined event may be configuring settings. Configuring settings may be a basic operation for enabling the interaction between electronic devices, and each electronic device may store a predetermined service that configures settings in association with a predetermined event that enters into a user network.

When the second electronic device 220 enters the user network, which is a predetermined event, the second electronic device 220 may attempt to configure settings with the first electronic device 210. The second electronic device 220 may attempt to configure the settings with other electronic devices that have entered the user network, in addition to the first electronic device 210.

The second electronic device 220 may transmit, to the first electronic device 210, an active notification to execute a predetermined service, that is, to induce configuring the settings, through the wired/wireless sharer 230. The first electronic device 210 that receives the active notification may display the active notification on a display unit. The first electronic device 210 may determine whether to configure settings with the second electronic device 220. When it is determined that the configuration of settings is to be executed, the first electronic device 210 may execute pairing with the second electronic device 220.

The first electronic device 210 may exchange information required to configure settings with the paired second electronic device 220. The first electronic device 210 exchanges information, downloads a driver and an app required to configure settings with the second electronic device 220, and installs the same based on the information. The first electronic device 210 may configure the settings with the second electronic device 220 through the installed driver or app, and may use the service of the second electronic device 220 after the configuration of settings is completed.

According to another embodiment of the present disclosure, an example will be described in which a predetermined service is executed between two electronic devices when a predetermined event occurs after the completion of the configuration of settings.

The description is provided by assuming that the first electronic device 210 is a smart phone and the second electronic device 220 is a printer.

The description will be provided by assuming that it is after the first electronic device 210 and the second electronic device 220 complete configuring settings with electronic devices, respectively.

The first electronic device 210 captures a photo using a contained camera application, and enters a user network. The wired/wireless sharer 230 that establishes the user network may transmit, to the second electronic device 220, information indicating that the first electronic device 210 enters the user network. The second electronic device 220 may receive information through a communication unit.

When a predetermined event occurs, the first electronic device 210 may transmit a notification to the second electronic device 220 to display the same. The predetermined event may be assumed to be an operation of executing a photo album application. It is assumed that a predetermined service that is matched to the predetermined event is an operation of outputting a recently captured photo. The second electronic device 220 may receive and display the notification. When the first electronic device 210 transmits the notification, the first electronic device 210 determines the state of the second electronic device 220, and may transmit the notification together with a wakeup command when the second electronic device 220 is in a sleep state.

When the second electronic device 220 determines to execute a predetermined service of the first electronic device 210, the second electronic device 220 may transmit a service start command. The first electronic device 210 may receive the command, and may transmit data for the execution of the predetermined service.

The second electronic device 220 may receive the data, and may output the recently captured photo, which is the service of the second electronic device 220.

According to another embodiment of the present disclosure, an example will be described in which a predetermined service is executed between two or more electronic devices when a predetermined event occurs. Referring to FIG. 3, the configuration of a network, according to various embodiments of the present disclosure, is formed of a first electronic device 310, a second electronic device 320, a third electronic device 330, and at least one wired/wireless sharer 340 that connects the electronic devices over a user network. The description will be provided by assuming that the first electronic device 310 is a smart phone, the second electronic device 320 is a camera, and the third electronic device 330 is TV. The wired/wireless sharer 340 may create a user network.

The description will be provided by assuming the situation in which the first electronic device 310, the second electronic device 320, and the third electronic device 330 have already completed configuring the settings with the electronic devices, respectively.

The first electronic device 310 and the third electronic device 330 may already enter the user network. After, the second electronic device 320 executes a function, such as capturing a photo, a video, and the like, and enters the user network. The wired/wireless sharer 340 that establishes the user network may transmit, to the first electronic device 310 and the third electronic device 330, information indicating that the second electronic device 320 enters the user network. Each of the first electronic device 310 and the third electronic device 330 may receive information through a corresponding communication unit.

When a predetermined event occurs, the second electronic device 320 may transmit a notification to the first electronic device 310 to display the same. The predetermined event may be assumed to be an operation of starting a slide show. Also, when the predetermined event occurs, the second electronic device 320 transmits a notification to other electronic devices in addition to the first electronic device 310 through the user network, for displaying the same. When a predetermined service that is matched to the predetermined event may be assumed to be an operation in which the third electronic device 330 displays a slide show.

When the first electronic device 310 receives the active notification, the active notification that the first electronic device 310 receives may be permission. The first electronic device 310 may display the received active notification on a display unit, and may permit the third electronic device 330 to execute the predetermined service of the second electronic device 320 based on a selection made by the user.

When the user selects permission in the first electronic device 310, the first electronic device may transmit a service start command to the second electronic device 320, and the second electronic device 320 that receives the command may transmit data for executing the predetermined service to the third electronic device 330. The third electronic device 330 may receive the data, and may execute the predetermined service of the second electronic device 320.

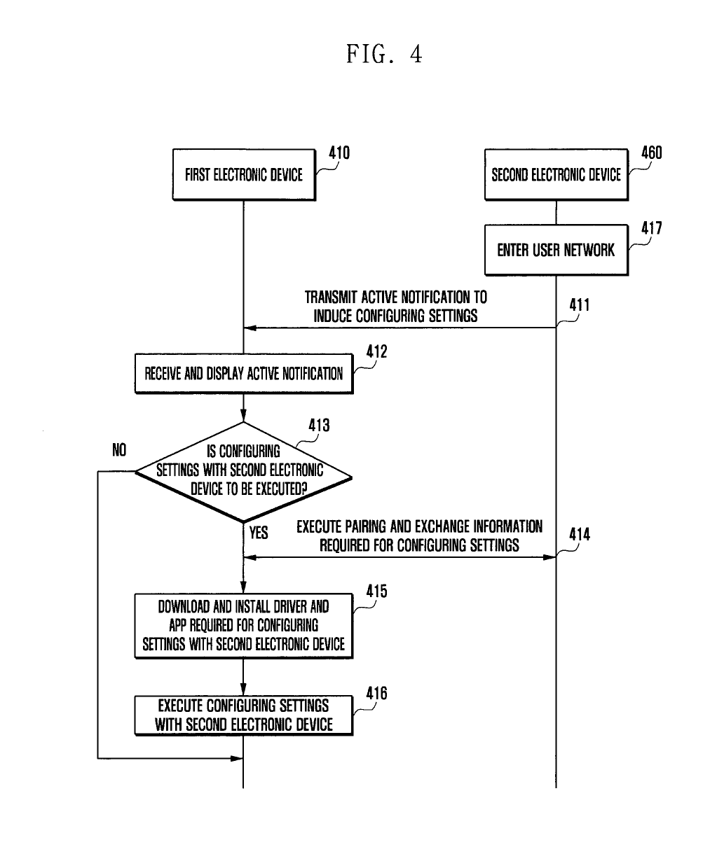

FIG. 4 illustrates a process of configuring settings between electronic devices according to various embodiments of the present disclosure.

Referring to FIG. 4, a first electronic device 410 enters a user network. The entrance into the network may be executed when a user makes a selection. In operation 417, a second electronic device 460 enters the user network where the first electronic device 410 has entered. A wired/wireless sharer may transmit, to the first electronic device 410, information indicating that the second electronic device 460 enters the user network. The first electronic device 410 may receive information through a communication unit. A predetermined event set in the second electronic device 460 may be the entrance into the user network, and a predetermined service that is stored by being matched to the predetermined event may be configuring the settings.

When the second electronic device 460 enters the user network, which is a predetermined event, the second electronic device 460 may attempt to configure the settings with the first electronic device 410. The second electronic device 460 may attempt to configure the settings with other electronic devices that have entered the user network, in addition to the first electronic device 410. Configuring the settings may be a basic operation for enabling the interaction between electronic devices, and each electronic device may store a predetermined service that configures the settings in association with a predetermined event that enters into a user network occurs.

In operation 411, the second electronic device 460 transmits, to the first electronic device 410, an active notification that induces configuring setting, which is a predetermined service. In operation 412, the first electronic device 410 that receives the active notification displays the active notification on a display unit.

In operation 413, the first electronic device 410 determines whether to configure settings with the second electronic device 460. When it is determined that configuring the settings is to be executed, the first electronic device 410 executes pairing with the second electronic device 460 in operation 414. The first electronic device 410 may exchange information required to configure the settings with the paired second electronic device 460.

The information required for configuring the settings may include network information, the properties of devices, a program (driver, application (apk)) for utilizing each device, and an address where the programs are downloaded, and the like. The information used for downloading an application from among the programs may include an address where the apk file of an application is directly downloaded. The information may include an address of a store where an application is downloaded.

For example, when the first electronic device 410 desires to use a service provided by the second electronic device 460, the information that the second electronic device 460 transmits may be an address where the driver, the application, or the like is downloaded, in association with the second electronic device 460, which the first electronic device 410 is required to have.

In operation 415, the first electronic device 410 exchanges information, downloads a driver and an application required to configure settings with the second electronic device 460, and installs the same based on the information. In operation 416, the first electronic device 410 may configure settings with the second electronic device 460 through the installed driver or application, and may use the service of the second electronic device 460 after the configuration of settings is completed.

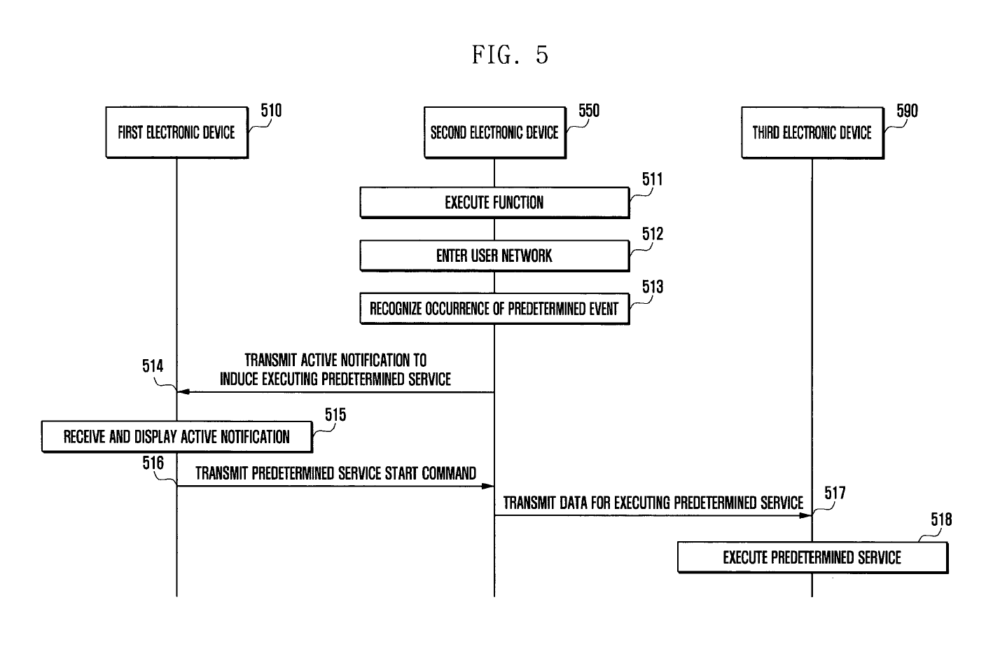

FIG. 5 illustrates a process of executing a service that is mutually usable between electronic devices according to various embodiments of the present disclosure. Before providing the description with reference to FIG. 5, note that it is assumed that each electronic device completes configuring settings with one another.

Referring to FIG. 5, it may be in the state in which a first electronic device 510 and a third electronic device 590 already entered a user network.

In operation 511, a second electronic device 550 executes a function of the electronic device. For example, when the second electronic device 550 is a camera, it may execute a function such as capturing a photo, a video, or the like.

In operation 512, the second electronic device 550 enters the user network. A wired/wireless sharer that establishes the user network may transmit, to the first electronic device 510 and the third electronic device 590, information indicating that the second electronic device 550 enters the user network. Each of the first electronic device 510 and the third electronic device 590 may receive information through a corresponding communication unit.

When the second electronic device 550 recognizes that a predetermined event occurs in operation 513, the second electronic device transmits a notification to the first electronic device 510 to display the same in operation 514.

According to an embodiment of the present disclosure, when an electronic device that is different from an electronic device that receives the notification is capable of executing a predetermined service that is matched to the predetermined event, the electronic device that receives the notification may provide permission.

In other words, in the case where the first electronic device 510 receives the active notification, when the active notification that the first electronic device 510 receives is a notification associated with a service that the third electronic device 590 executes, or a notification associated with a service that the third electronic device 590 is capable of executing, the active notification that the first electronic device 510 receives may be permission.

In operation 515, the first electronic device 510 displays the received active notification on a display unit, receives a selection made by a user, and permits the third electronic device 590 to execute the predetermined service of the second electronic device 550.

When the user selects the permission in the first electronic device 510, the first electronic device transmits a service start command to the second electronic device 550 in operation 516. The second electronic device 550 that receives the same in operation 516 may transmit data for executing the predetermined service to the third electronic device 590 in operation 517.

In operation 518, the third electronic device 590 receives the data, and executes the predetermined service of the second electronic device 550.

For example, it is assumed that the first electronic device 510 is a smart phone, the second electronic device 550 is a notebook, and the third electronic device 590 is a printer. The note book may write a document using one of the functions.

The notebook may enter the user network where the smart phone and the printer are connected. The smart phone and the printer may recognize that the notebook enters the user network.

The notebook may recognize that a print-out button is recognized in association with the written document. As a predetermined event of the notebook, the recognition of a document print-out button may be set in advance. As the notebook recognizes the predetermined event, the notebook may transmit, to the smart phone, an active notification that induces printing out a document, which is a predetermined service matched to the predetermined event.

Here, according to an embodiment of the present disclosure, the notebook may transmit an attribute of a predetermined service together with the activation notification. That is, a property of printing out may be included. Therefore, when the smart phone, which is incapable of printing output, receives the active notification, the smart phone may permit or instruct the notebook to execute a service with a printer that is capable of printing out a document. The electronic devices may exchange properties of the electronic devices when configuring the settings.

Also, the notebook selects an electronic device to execute a predetermined service when setting a predetermined service to be matched to a predetermined event. In other words, the notebook may set a printer to execute printing out a document, which is a predetermined service matched to a predetermined event that recognizes a print-out button. Therefore, although the smart phone receives an active notification associated with a predetermined event from the notebook, the smart phone may instruct or permit the printer to execute a predetermined service.

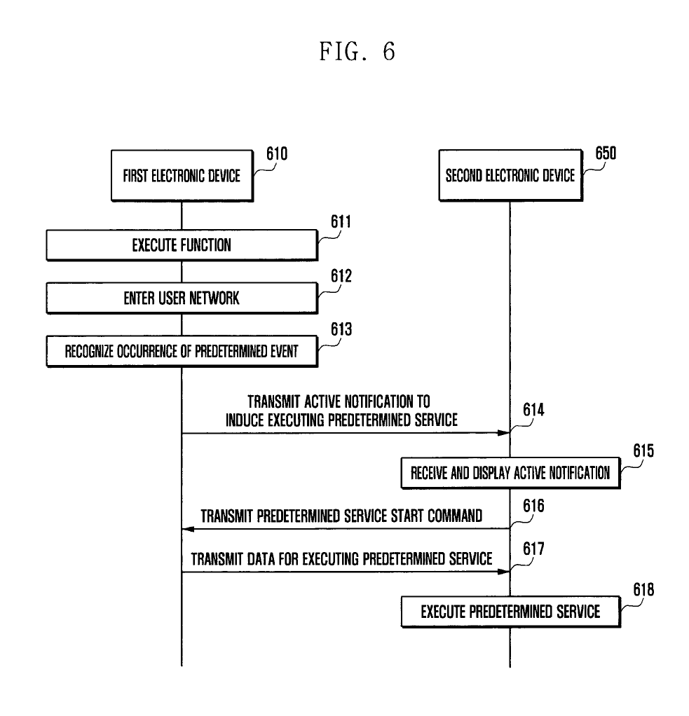

FIG. 6 illustrates a process of executing a service that is mutually usable between electronic devices according to various embodiments of the present disclosure. Before providing the description with reference to FIG. 6, note that it is assumed that each electronic device completes configuring settings with one another.

Referring to FIG. 6, a second electronic device 650 enters a user network.

In operation 611, a first electronic device 610 executes a function of the electronic device. For example, when the electronic device is a camera, the electronic device may capture a photo, a video, and the like. In operation 612, the first electronic device 610 enters a user network. A wired/wireless sharer that establishes the user network may transmit, to the second electronic device 650, information indicating that the first electronic device 610 enters the user network. The second electronic device 650 may receive the information through a communication unit.

When the first electronic device 610 recognizes that a predetermined event occurs in operation 613, the first electronic device 610 transmits a notification to the second electronic device 650 in operation 614.

In operation 615, the second electronic device 650 receives and displays the received active notification. In operation 616, when the second electronic device 650 recognizes a user's selection that permits a predetermined service in association with the predetermined event, the second electronic device 650 transmits a predetermined service start command.

The first electronic device 610 that receives the predetermined service start command may transmit data for executing the predetermined service, in operation 617. That is, in operation 617, the first electronic device 610 receives the command, and transmits data for the execution of the predetermined service. In operation 618, the second electronic device 650 executes the predetermined service.

For example, it is assumed that the first electronic device 610 is a camera, and the second electronic device 650 is TV. The camera may execute a function of photographing a video. The camera may enter the user network where TV is connected. The TV may recognize that the camera enters. A video playback button may be selected by the user in the camera. As a predetermined event of the camera, the recognition of selection of a video playback button may be set. A predetermined service matched to the predetermined event may be the playback of a video.

When the camera recognizes the selection of the video playback button, the camera may transmit an active notification to the TV to execute a video playback service. The TV that receives the active notification may display the active notification. When the user determines that an active notification message displayed on the display unit of the TV, and gives permission, the TV may transmit a predetermined service start command. The camera that receives the command may transmit a video file that contains data for playing back a video. The TV may receive the data, and may play back a video that is a predetermined service.

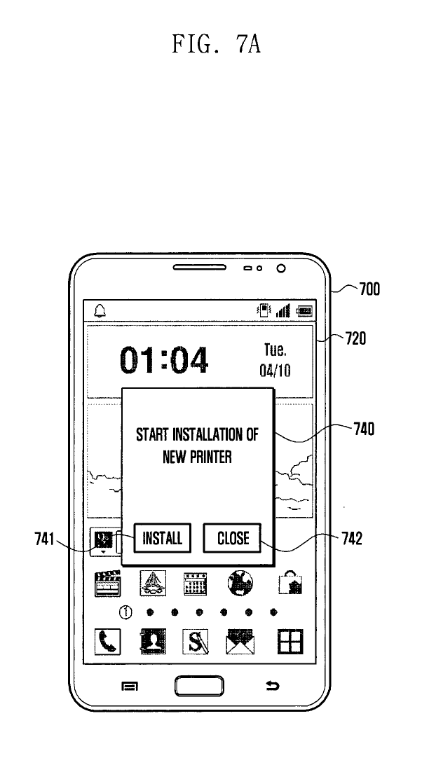

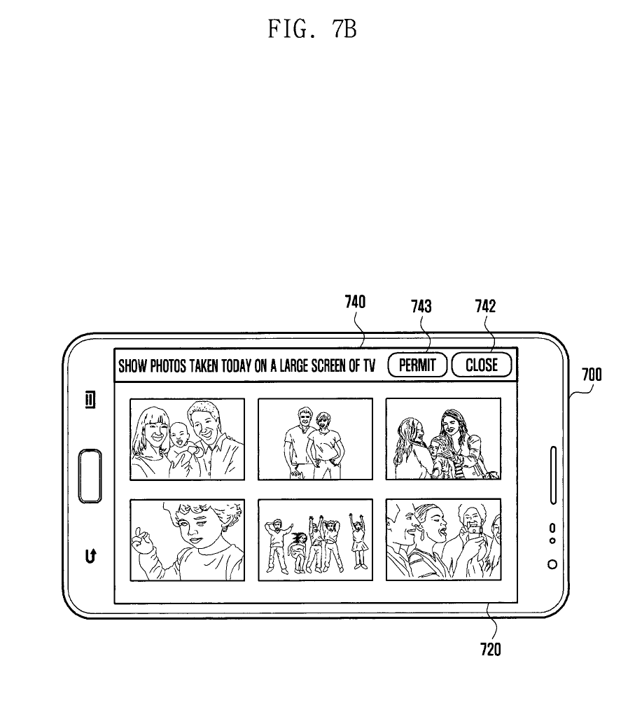

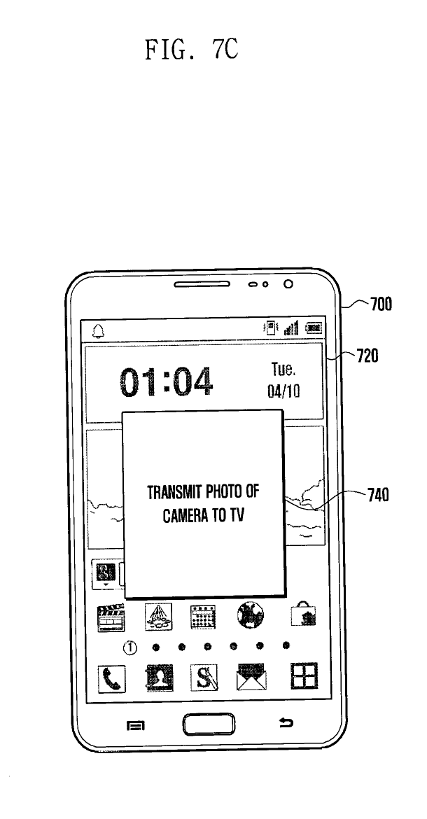

FIGS. 7A to 7C illustrate an active notification according to various embodiments of the present disclosure.

According to an embodiment of the present disclosure, when it is assumed that a first electronic device 700 is a smart phone and a second electronic device is a printer, configuring the settings may be executed when the smart phone and the printer share a single network. Particularly, when the printer enters the network where the smart phone uses, the printer transmits an active notification that induces configuring the settings, and the smart phone receives the active notification and displays the same as illustrated in FIG. 7A. Referring to FIG. 7A, a display unit 720 of the smart phone, which is the first electronic device 700, may include an active notification 740 that induces configuring settings. The active notification 740 may include an install button 741 and a close button 742, and may require the user to make a selection.

According to another embodiment of the present disclosure, when it is assumed that the first electronic device 700 is a smart phone and the second electronic device is a TV, each electronic device may execute a service when the smart phone and the TV share a single network. As a predetermined event of the smart phone, a function of outputting photos stored in the gallery to a TV screen may be set in advance. The TV recognizes the predetermined event of the smart phone, and may display an active notification on the TV so as to execute outputting a photo to the TV, which is a predetermined service. Also, as illustrated in FIG. 7B, the smart phone may display, on the display unit 720, the active notification that induces the connection with the TV. The active notification 740 may include a permission button 746 and a close button 742, and may require the user to make a selection.

According to another embodiment of the present disclosure, when it is assumed that the first electronic device 700 is a smart phone, a second electronic device is a TV, and a third electronic device is a camera, each electronic device may execute a service when the devices share a single network. As a predetermined event of the camera, executing a photo album may be set in advance. The camera may recognize the predetermined event, and may transmit the same to the smart phone in order to report a predetermined service, which displays a slide show on TV. The smart phone may receive the active notification 740, and may display the same as illustrated in FIG. 7C.

The computer-readable storage medium includes magnetic media such as a floppy disk and a magnetic tape, optical media including a Compact Disc (CD) ROM and a Digital Video Disc (DVD) ROM, a magneto-optical media such as a floptical disk, and the hardware device designed for storing and executing program commands such as ROM, RAM, and flash memory. The programs commands include the language code executable by computers using the interpreter as well as the machine language codes created by a compiler. The aforementioned hardware device can be implemented with one or more software modules for executing the operations of the various embodiments of the present disclosure.

The module or programming module of the present disclosure may include at least one of the aforementioned components with omission of some components or addition of other components. The operations of the modules, programming modules, or other components may be executed in series, in parallel, recursively, or heuristically. Also, some operations may be executed in different order, omitted, or extended with other operations.

Although the present disclosure has been described with an embodiments, various changes and modifications may be suggested to one skilled in the art. It is intended that the present disclosure encompass such changes and modifications as fall within the scope of the appended claims.

What is claimed is:

1. An electronic device for executing an active notification for an interaction between electronic devices, the electronic device comprising:
a memory configured to store a matching predetermined event and predetermined service;
a communication unit configured to transmit and receive an active notification and information associated with the predetermined service, with external electronic devices over a network, based on whether the predetermined event occurs; and
a controller configured to:
recognize, using the communication unit, the entrance of an external electronic device into the network,
receive the active notification from the external electronic device,
determine whether to execute the predetermined service based on the received active notification,
exchange the information associated with the predetermined service with the external electronic device when it is determined that the predetermined service is to be executed, and
execute the predetermined service based on the information.

2. The electronic device of claim 1, wherein the predetermined service includes configuring settings with the external electronic device.

3. The electronic device of claim 1, wherein, when the received active notification is a notification to induce configuring settings, the information includes a driver and application download address.

4. The electronic device of claim 1, wherein the controller is further configured to:
when an execution command for the predetermined service is transmitted to the external electronic device, exchange information required for executing the predetermined service with the external electronic device.

5. The electronic device of claim 1, wherein the active notification is received when the external electronic device recognizes that the predetermined event which is matched to the predetermined service occurs.

6. A method of executing an active notification for an interaction between electronic devices, the method comprising:
recognizing entrance of an external electronic device into a network;
receiving an active notification from the external electronic device;
determining whether to execute a predetermined service based on the received activation notification;
exchanging, with the external electronic device, information required for executing the predetermined service when it is determined that the predetermined service is to be executed; and
executing the predetermined service based on the received information.

7. The method of claim 6, wherein the predetermined service includes configuring settings with the external electronic device.

8. The method of claim 6, wherein, when the received active notification is a notification to induce configuring settings, the information includes a driver and application download address.

9. The method of claim 6, wherein the exchanging is executed when an execution command for the predetermined service is transmitted to the external electronic device.

10. The method of claim 6, wherein the active notification is received when the external electronic device recognizes that a predetermined event that is matched to the predetermined service occurs.

11. An electronic device for executing an active notification for an interaction between electronic devices, the electronic device comprising:
a memory configured to store a matching predetermined event and predetermined service, and storing the same;
a communication unit configured to transmit and receive an active notification and information associated with the predetermined service with external electronic devices over a network, based on whether the predetermined event occurs; and
a controller configure to:
execute an entrance into the network,
inform the external electronic device of whether the entrance is executed,
transmit an active notification to the external electronic device,
receive, from the external electronic device, an execution command for the predetermined service based on the active notification, and
exchange information required for the external electronic device to execute the predetermined service.

12. The electronic device of claim 11, wherein the predetermined service includes configuring settings with the external electronic device.

13. The electronic device of claim 12, wherein the active notification is transmitted when the predetermined event that is matched to the predetermined service is recognized.

14. The electronic device of claim 11, wherein, when the received active notification is a notification to induce configuring settings, the information includes a driver and application download address.

15. A method of executing an active notification for an interaction between electronic devices, the method comprising:
entering a network, and informing an external electronic device of whether the entrance is executed;
transmitting an active notification to the external electronic device;
receiving an execution command for a predetermined service from the external electronic device; and
exchanging, with the external electronic device, information required to execute the predetermined service.

16. The method of claim 15, wherein the predetermined service configures settings with the external electronic device.

17. The method of claim 16, wherein the active notification is transmitted when the predetermined event that is matched to the predetermined service is recognized.

18. The method of claim 15, wherein, when the received active notification is a notification to induce configuring settings, the information includes a driver and application download address.
